(19) United States
(12) Patent Application Publication
(10) Pub. No.: US 2004/0243967 A1
(43) Pub. Date: Dec. 2, 2004

(54) Semiconductor design layout pattern formation method and graphic pattern formation unit

(75) Inventors: Minoru Yamagiwa, Takatsuki-shi (JP); Tadashi Tanimoto, Otsu-shi (JP); Akio Misaka, Suita-shi (JP); Reiko Hinogami, Kawabe-gun (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/851,294

(22) Filed: May 24, 2004

(30) Foreign Application Priority Data
May 28, 2003 (JP) 2003-151003

(51) Int. Cl. G06F 17/50

(52) U.S. Cl. 716/19; 716/5

(57) ABSTRACT

Reduction in labor of the operations for evaluating the amount of retrogression of end portions in a line pattern, and the simplification of the CAD processing for a mask are achieved. A semiconductor design layout pattern formation method is provided concerning a layout pattern on a wafer, wherein the designed wire lines do not have the same pitch, and wherein a dummy graphic pattern having no relation to wiring is formed in a non-wired region of the layout pattern so that the interval between the dummy graphic pattern and the adjacent wiring line becomes equal to the intervals of wiring lines. It becomes possible to make uniform the pitch of the end portions of lines in the design layout pattern on the wafer, so that the dispersion in the change of the form (retrogression) of the end portions of the lines can be restricted. Thereby, the amount of retrogression on the wafer can be made uniform, so that the specification of the formation of hammer graphics can be simplified, and it becomes possible to reduce the time period necessary for mask CAD processing, and also to reduce the amount of mask data.

### BACKGROUND OF THE INVENTION

1. Field of the Invention

The present invention relates to a photo mask data processing technology for compensating pattern deterioration in a wafer process of a semiconductor manufacturer. In addition, the present invention relates to a semiconductor design layout pattern formation method and a graphic pattern formation unit concerning photo mask data.

2. Description of the Prior Art

End portions of the lines of the semiconductor design layout pattern are significantly recessed on a wafer, and therefore an auxiliary pattern, which is referred to as a hammer (or, serif) pattern, is added to the end portions of the lines in the mask data, in order to prevent the change of the pattern on the wafer.

The amount of retrogression of the end portions of the lines in a layout pattern on a wafer is, in general, estimated by carrying out experiments, and hammer graphics having a certain size and shape are added to the end portions of the lines. Line width 1 of layout pattern 0, as shown in FIG. 18, for example, is measured; and a hammer graphic 4 having a certain size is uniformly added to an end portion of a line in accordance with length 2 of an edge between the end portions of the line, and in accordance with distance 3 vis-à-vis the opposite line.

A method gained by improving the above has been proposed, wherein distance 5 between hammer graphic 4 and the opposite line is measured after the hammer graphic is added to an end portion of a line, and pattern 6 to be removed from the hammer graphic is created in accordance with the distance vis-à-vis the opposite line so that this is removed (retrogressed) from the hammer graphic and thereby the amount of change in the end portion of the line is corrected with a high precision.

References concerning the above described prior art are: “Pattern Correction Method of Masks for Semiconductor Manufacture, and Recording Medium that Records Pattern Correction Method (Japanese Unexamined Patent Publication 2001-83689 (Claims 1 and 2 on page 2)),” and “Mask Pattern Correction Method, Pattern Formation and Photo Mask (Japanese Unexamined Patent Publication H08 (1997)-321450).”

Sufficient precision in correction cannot be gained according to the above described masked pattern correction method according to the prior art, however, unless the amount of regression of an end portion is evaluated for each combination of an edge portion of a line pattern and a peripheral pattern so that the amount of correction is set for this value. A tremendous amount of evaluation tasks become necessary in order to evaluate the amount of regression for each combination of an end portion of a line pattern and a peripheral pattern, and in addition a very long period of time becomes necessary for a mask CAD processing for carrying out correction processing for each of the combinations.

### SUMMARY OF THE INVENTION

An object of the present invention is to provide, in view of the above described problem, a semiconductor design layout pattern formation method, and a graphic pattern formation unit that can achieve the reduction of labor for the evaluation tasks, and a simplification of the mask CAD processing; wherein the evaluation of the amount of regression of an end portion of the line pattern is not required taking into account the relationship between the end portion of each line pattern and a peripheral pattern when the end portion of each line pattern is corrected.

In order to achieve the above described object, the semiconductor design layout pattern formation method of the first invention is a semiconductor design layout pattern formation method in a layout pattern wherein wiring lines are not designed so as to have a uniform pitch on a wafer, and wherein a demographic pattern is formed, in a non-wired region in a layout pattern, so that the demographic pattern which does not relate to the pattern and the wire lines have the same intervals.

It becomes possible to make the pitch of the end portions of the lines uniform in the design layout pattern on a wafer, and thereby the dispersion of change (retrogression) in the end portions of the lines can be restricted according to this configuration. Thereby, the amount of retrogression on a wafer can be made uniform, and therefore the specification for the creation of a hammer graphic can be simplified so that reduction in time for mask CAD processing, and it becomes possible to reduce the amount of mask data.

The semiconductor design layout pattern formation method of the second invention is a semiconductor design layout pattern formation method in a layout pattern, wherein wiring lines are not designed so as to have a uniform pitch on a wafer, and wherein a microscopic graphic pattern is formed in a non-wired region in a layout pattern, so that the microscopic graphical pattern which doesn't relate to wires and which is not resolved on a wafer by means of a projection optimal system and wire lines have the same intervals.

It becomes possible to make the pitch of the end portions of the lines uniform in the design layout pattern on a wafer, and thereby the dispersion of change (retrogression) in the end portions of the lines can be restricted according to this configuration. Thereby, the amount of retrogression on a wafer can be made uniform, and therefore the specification for the creation of a hammer graphic can be simplified in the same manner as in the first invention.

The semiconductor design layout pattern formation method of the third invention is a semiconductor design layout pattern formation method in a layout pattern, wherein wiring lines are not designed so as to have a uniform pitch on a wafer, and which includes the step of making a uniform space between the end of portion of every wiring line, and the pattern aligned in the same direction as the corresponding wiring line in a layout pattern.

This configuration includes the step of making a uniform space between the end of portion of every wiring line, and the pattern aligned in the same direction as the corresponding wiring line in a layout pattern, and therefore the effect of the wiring pitch to the end of portions of lines becomes slight, so that the dispersion of the change (retrogression) of the end of portions of the lines can be restricted by making a uniform space between the opposite end portions of the wiring lines. Thereby, the amount of retrogression on a wafer can be uniformed, and thereby the specification of the hammer graphic formation can be simplified in the same manner as in the first image.

The semiconductor design layout pattern formation method of the fourth invention is a semiconductor design layout pattern formation method used to form a desired layout pattern on a wafer by means of a projection optics system, and which includes the step of sampling an edge of an end portion of a line in a layout pattern; the step of calculating the edge interval between the edge of the end portion of the line and the adjacent edge, and of sampling an edge that becomes a correction object based on this calculation result; and the step of making the edge interval uniform by shifting the edge which has become the correction object toward the adjacent edge.

It becomes possible to make the amount of retrogression of end of portions of lines on a wafer uniform, by adjusting the space between the opposite end portions of the lines to a regulated interval in the design layout pattern on a wafer according to the above configuration. In addition, the amount of retrogression on a wafer is made uniform, and thereby the specification of the hammer graphic formation can be simplified and it becomes possible to reduce the time for mask CAD processing, and to reduce the amount of mask data.

The semiconductor design layout pattern formation method of the fifth invention is a semiconductor design layout pattern formation method used to form a desired layout pattern on a wafer by means of a projection optics system, and which includes; the step of sampling an edge of an end portion of a line in a layout pattern in accordance with the density of the peripheral pattern; the step of calculating the edge interval between the edge of the end portion of the line and the adjacent edge, and of sampling an edge that becomes a correction object based on this calculation result; and the step of shifting the edge which has become the correction object toward the adjacent edge, wherein the amount of shifting of the edge is varied according to the density of the pattern at the step of shifting the edge so that the density of the pattern becomes uniform.

It becomes possible to make the amount of retrogression of the end portions of the lines on the wafer uniform in accordance with the density of the pattern, that is found from the ratio of the edges wherein the space between the opposed end portions of the lines exceeds the standard space in the design layout pattern on a wafer according to the above described configuration. In addition, the amount of the retrogression on a wafer is made uniform and thereby the specification of the hammer graphic formation can be simplified, in the same manner as in the fourth invention.

The semiconductor design layout pattern formation method of the sixth invention is the semiconductor design layout pattern formation method that is used to form a desired layout pattern on a wafer by means of a projection optics system, which includes the step of sampling an edge of an end portion of a line in the vertical direction in the layout pattern; the step of calculating the edge interval between the edge of the end portion of the line and the adjacent edge, and of sampling the edge that becomes a correction object based on this calculation result; and the step of shifting the edge that becomes the correction object toward the adjacent edge, wherein the amount of edge that can be shifted is calculated in accordance with the edge interval at the step of shifting the edge.

The space between the opposed end portions of the lines in the vertical direction in the design layout pattern on a wafer satisfies the standard interval, and thereby it becomes possible to make the amount of retrogression of the end of portions of the lines on a wafer uniform. In addition, the amount of the retrogression on a wafer is made uniform and thereby the specification of the hammer graphic formation can be simplified, in the same manner as in the fourth invention.

The semiconductor design layout pattern formation method of the seventh invention is the semiconductor design layout pattern formation method that is used to form a desired layout pattern on a wafer by means of a projection optics system, which includes the step of sampling an edge of an end portion of a line in the horizontal direction in the layout pattern; the step of calculating the edge interval between the edge of the end portion of the line and the adjacent edge, and of sampling the edge that becomes a correction object based on this calculation result; and the step of shifting the edge that becomes the correction object toward the adjacent edge, wherein the amount of edge that can be shifted is calculated in accordance with the edge interval at the step of shifting the edge.

The space between the opposed end portions of the lines in the horizontal direction in the design layout pattern on a wafer satisfies the standard interval, and thereby it becomes possible to make the amount of retrogression of the end of portions of the lines on a wafer uniform. In addition, the amount of the retrogression on a wafer is made uniform and thereby the specification of the hammer graphic formation can be simplified, in the same manner as in the fourth invention.

The semiconductor design layout pattern formation method of the eighth invention is the semiconductor design layout pattern formation method that is used to form a desired layout pattern on a wafer by means of a projection optics system, which includes the step of sampling an edge of an end portion of a line in the layout pattern; the step of calculating the edge interval between the edge of the end portion of the line and the adjacent edge, and of sampling the edge that becomes a correction object based on this calculation result; the step of forming an extension pattern of the end portion of the line in accordance with the edge interval; and the step of replacing the extension pattern with the edge which becomes the correction object so as to uniform the edge interval.

The space between the opposed end portions of the lines in the design layout pattern on a wafer satisfies the standard interval, and thereby it becomes possible to make the amount of retrogression of the end of portions of the lines on a wafer uniform. In addition, the amount of the retrogression on a wafer is made uniform and thereby the specification of the hammer graphic formation can be simplified, in the same manner as in the fourth invention.

The semiconductor design layout pattern formation method of the ninth invention is the semiconductor design layout pattern formation method of the eighth invention that includes: the step of calculating the edge interval between the edge of an end portion of a line and the adjacent edge in the layout pattern after the extension pattern has been replaced and of sampling the edge that becomes the correction object based on this calculation result; the step of forming a center graphic referencing the center of the edge interval concerning the edge that becomes the correction object; and the step of removing the center graphic from the extension pattern.

It becomes possible for all of the end portions of the lines within the entire layout pattern to secure the standard space in the above described configuration.

The graphic pattern formation unit of the tenth invention is provided with a means for making the pitch uniform between the wires and the peripheral patterns according to the semiconductor design layout pattern formation method of the first or second invention.

The effect of retrogression of the end portions of the lines in the pattern on a wafer can be uniformed according to the above described configuration.

The graphic pattern formation unit of the eleventh invention is provided with a means for making uniform the space between an end portion of a line and the pattern aligned in the direction of this line in the layout pattern according to the semiconductor design layout pattern formation method of the fourth, fifth, sixth, seventh or eighth invention.

The effect of the retrogression of the end portions of the lines in the pattern on a wafer can be uniformed according to the above described configuration.

### BRIEF DESCRIPTION OF THE DRAWINGS

FIG. 1 is a plan view of a layout pattern after the formation of a dummy graphic pattern in the first embodiment of the present invention;

FIG. 2 is a plan view of a layout pattern after the formation of an auxiliary pattern in the second embodiment of the present invention;

FIG. 3 is a plan view of end portions of lines in the layout pattern in the third embodiment of the present invention;

FIG. 4 is a flow chart of the semiconductor design layout pattern formation method of the fifth embodiment of the present invention;

FIG. 5 is a plan view of an extension pattern of end portions of lines to the maximum dimensions in the vertical direction in the fifth embodiment;

FIG. 6 is a plan view of a retrogression pattern of end portions of lines in the vertical direction in the fifth embodiment;

FIG. 7 is a plan view of an extension pattern of end portions of lines to the maximum dimensions in the horizontal direction in the fifth embodiment;

FIG. 8 is a plan view of a retrogression pattern of end portions of lines in the horizontal direction in the fifth embodiment;

FIG. 9 is a flow chart of the semiconductor design layout pattern formation method of the sixth embodiment of the present invention;

FIG. 10 is a plan view of an extension pattern of end portions of lines to a stage in the vertical direction in the sixth embodiment;

FIG. 11 is a plan view of an extension pattern of end portions of lines to a stage in the vertical direction in the sixth embodiment;

FIG. 12 is a plan view of an extension pattern of end portions of lines to a stage in the horizontal direction in the sixth embodiment;

FIG. 13 is a plan view of an extension pattern of end portions of lines to a stage in the horizontal direction in the sixth embodiment;

FIG. 14 is a flow chart of the semiconductor design layout pattern formation method of the seventh embodiment of the present invention;

FIG. 15 is a plan view of an extension pattern of end portions of lines to the maximum dimensions in the seventh embodiment;

FIG. 16 is a plan view of the layout pattern after the standard dimensions have been secured in the seventh embodiment;

FIG. 17 is a plan view of the layout pattern after OPC processing; and

FIG. 18 is a plan view of the hammer graphic formation method according to the prior art.

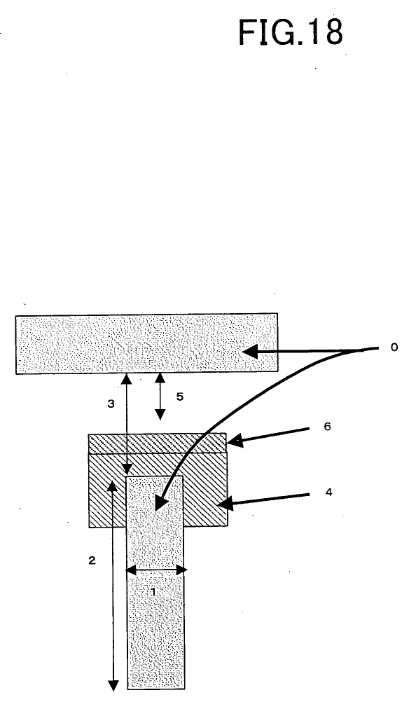

### DETAILED DESCRIPTION OF THE PREFERRED EMBODIMENTS

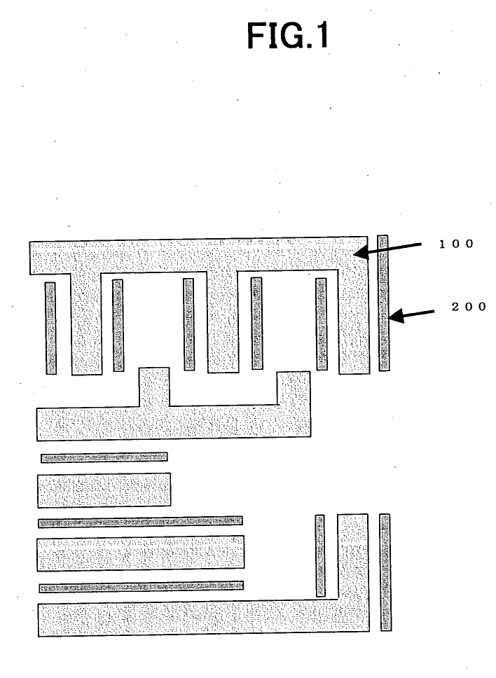

The first embodiment of the present invention is below described in reference to FIG. 1. FIG. 1 is a plan view of the layout pattern after the formation of a dummy graphic pattern according to the semiconductor design layout pattern formation method of the first embodiment of the present invention.

In FIG. 1 the entire layout pattern is denoted as 100 and a dummy pattern is denoted as 200. As shown in FIG. 1, dummy graphic pattern 200 which does not relate to other wires is placed between wire lines (non-wired region) in order to make the effect of end portions of lines on a wafer uniform so that the wire lines have the same pitch in the case wherein the wire lines are not designed to have the same pitch in design layout pattern 100. That is to say, this pattern formation method includes the step of forming the above described dummy graphic pattern 200, wherein the above described step is set so that the intervals between dummy graphic pattern 200 and wire lines become the same. Thereby, the effect of retrogression of end portions of lines in the pattern on a wafer can be uniformed.

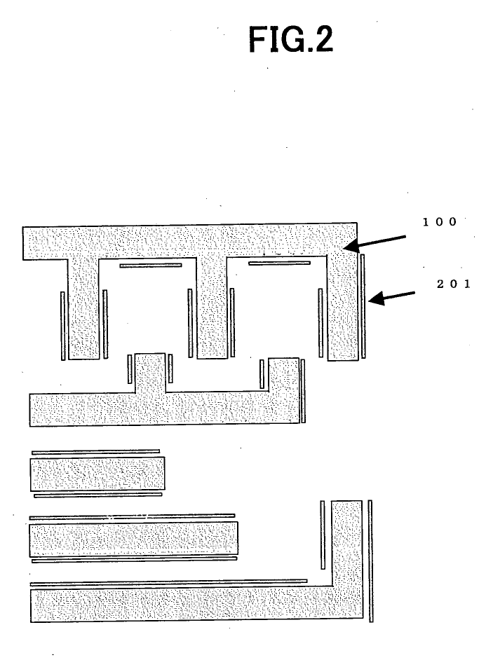

The second embodiment of the present invention is below described in reference to FIG. 2. FIG. 2 is a plan view of the layout pattern after the formation of an auxiliary pattern according to the semiconductor design layout pattern formation method of the second embodiment of the present invention.

In FIG. 2, the entire layout pattern is denoted as 100 and an auxiliary pattern is denoted as 201. As shown in FIG. 2, a microscopic graphic pattern (scattering bar or assist bar) 201 which doesn't relate to other wires between wire lines (non-wired region) and which is not resolved on the wafer by means of a projection optics system is formed in order to make the effect of end portions of lines on the wafer uniform so that the wire lines are designed to have the same pitch in the case wherein wire lines of design layout pattern 100 are not designed to have the same pitch. That is to say, this pattern formation method includes the step of the formation of the above described microscopic graphic pattern, wherein the above described step is set so that the intervals between the microscopic graphic pattern and the wire lines become equal.

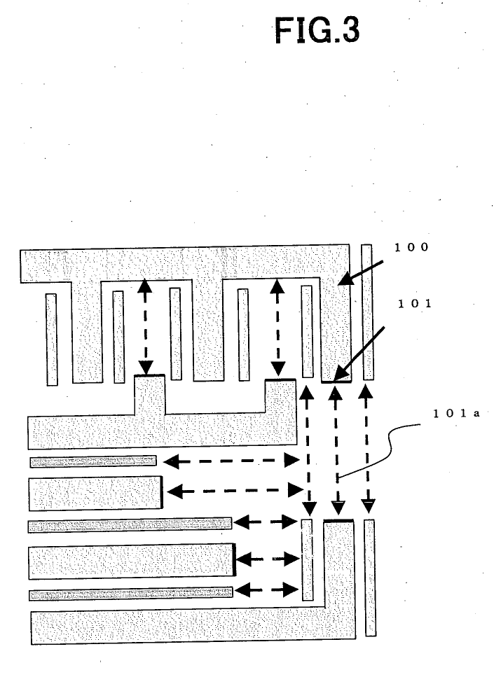

The third embodiment of the present invention is below described in reference to FIG. 3. FIG. 3 is a plan view of end portions of lines in the layout pattern according to the semiconductor design layout pattern formation method of the third embodiment of the present invention.

In FIG. 3, the entire layout pattern is denoted as 100 and end portions of lines having an interval equal to or greater than the standard interval are denoted as 101. As shown in FIG. 3, the effect of the wire pitch to end portions of lines is small and only the intervals of spaces 101a between end portions 101 of wire lines are made uniform in the case wherein the wire lines of design layout pattern 100 are designed to have the same pitch. That is to say, this pattern formation method includes the step of making uniform a space 101a between an end portion 101 of a wire line and the pattern aligned in the direction of this sire line. Thereby, the effect of retrogression of end portions of lines in the pattern on a wafer can be uniformed.

The fourth embodiment of the present invention is below described.

The step of finding the ratio of the edges wherein the space between the opposed end portions of lines is equal to or greater than the standard space from among the end portions of lines in the entire chip in the layout pattern wherein the wire intervals are designed to have the same pitch is carried out according to this embodiment.

End portions of lines are altered so as to be reflected in the source data of the design layout pattern in the case wherein the above found ratio of the end portions of lines having a space equal to or greater than the standard space is greater than the standard ratio. The end portions of lines are altered in a manner wherein end portions of lines are expanded according to Embodiment 5, Embodiment 6 or Embodiment 7 so that the intervals between the opposed end portions of lines are uniformed.

The effect of end portions of lines on a wafer is small and no end portions of lines in the source data of the design layout pattern are not altered when line end portion OPC processing is carried out in the case wherein the above found ratio of the end portions of lines having a space equal to or greater than the standard space is smaller than the standard ratio.

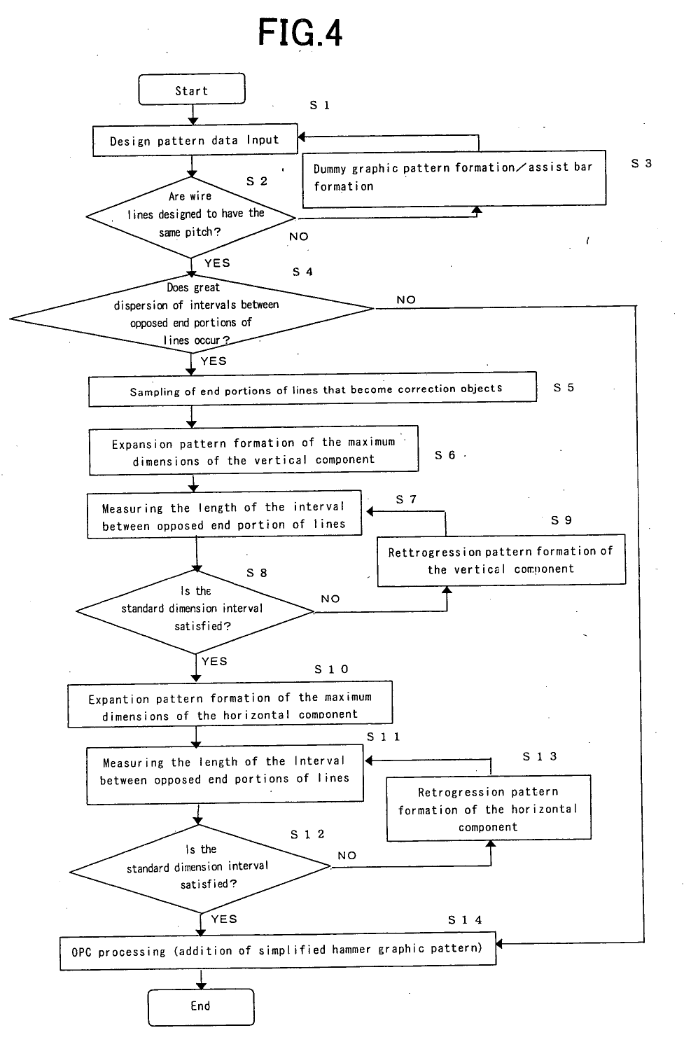

The fifth embodiment of the present invention is below described in reference to FIGS. 4 to 8. FIG. 4 is a flow chart of the semiconductor design layout pattern formation method of the fifth embodiment of the invention.

This embodiment includes the step of sampling an edge of an end portion of a line in the layout pattern; the step (S5) of calculating the edge interval between the edge of the end portion of the line and the adjacent edge and of sampling an edge that becomes a correction object based on this calculation result; and the step of making the edge interval uniform by shifting the edge that becomes the correction object toward the adjacent edge, at the time when the forms of end portions of lines are changed according to the fourth embodiment as shown in FIG. 4.

In this case, the extension pattern having the maximum dimensions is formed at an end portion of a line in the design layout pattern (S6). After the formation of the extension pattern the interval between the opposed end portions of lines is measured and the extension pattern is replaced with an extension pattern having a smaller (retrogressed) extension pattern by one stage in the case wherein the standard interval is not satisfied (in the case of a design error) and the dimensions of the extension pattern are reduced step by step until the standard interval is satisfied (S7 to S9).

The procedure of the CAD processing algorithm for correcting end portions of lines is shown in the below.

End portions 101 of lines in the vertical direction having intervals between the opposed end portions equal to or greater than the standard are sampled from the entire layout patter 100 (S5).

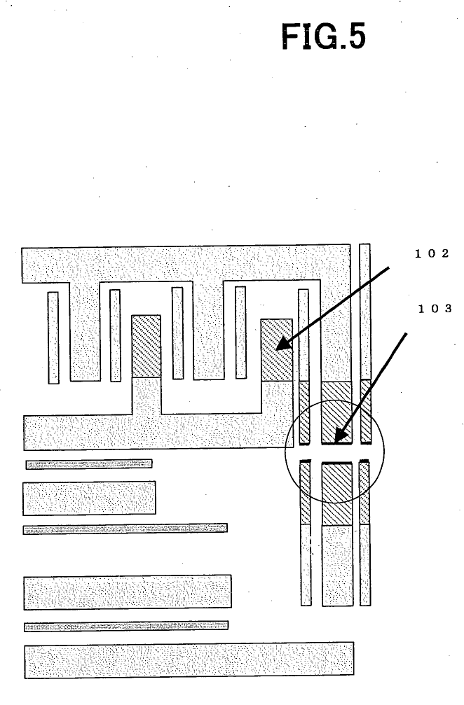

A pattern 102 that has been expanded by the maximum dimensions in the vertical direction is formed at an end portion 101 of lines as shown in FIG. 5 (S6).

The intervals between the end portions of lines are measured so that end portions 103 of lines that do not satisfied the standard interval (causing a design error) are sampled from the entire layout pattern that has been formed in S6 (S7, S8).

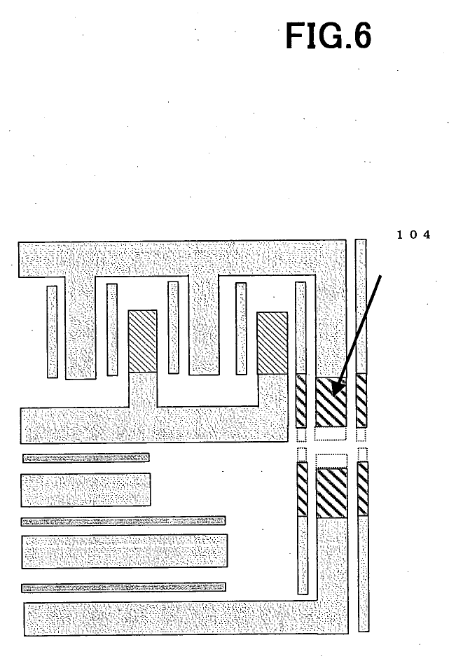

As shown in FIG. 6, expansion pattern 102 is replaced with an expansion pattern 104 which has retrogressed by an arbitrary dimension from end portion 103 of the line (S9).

The processes of S7 to S9 are repeated until the interval between the opposed end portions of a line in the vertical direction satisfies the standard interval.

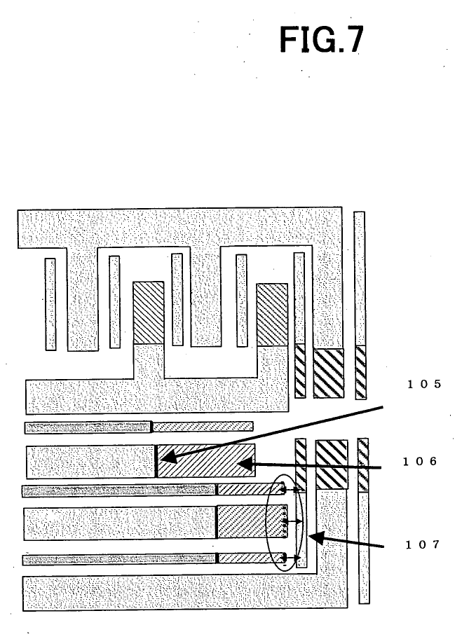

Next, end portions 105 of lines having intervals in the horizontal direction between the end portions equal to or greater than the standard interval are sampled from the entire layout pattern that has been formed in the steps S5 to S9 and a pattern 106 wherein end portions 105 of lines are expanded by the maximum dimensions only in the horizontal direction are formed as shown in FIG. 7 (S10).

The intervals between the opposed end portions of the lines are measured and end portions 107 of lines which do not satisfy the standard interval (cause a design error) are sampled from the entire layout pattern that has been formed in S10 (S11, S12).

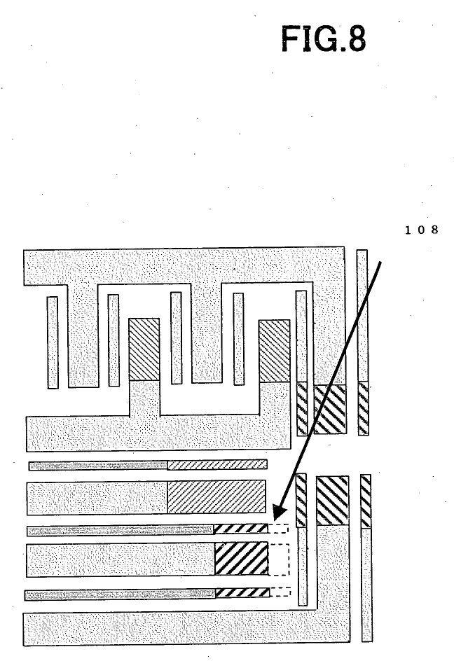

As shown in FIG. 8, expansion pattern 106 that has been formed at end portion 107 of a line is replaced with an expansion pattern 108 wherein an arbitrary dimension has retrogressed from expansion pattern 106 (S13).

The processes of S11 to S13 are repeated until the intervals between the opposed end portions of lines in the horizontal direction satisfy the standard interval and, thereby, it becomes possible for the end portions of the lines to satisfy the standard interval (pitch) in the entire layout pattern.

Here, edges of end portions of lines in the layout pattern are sampled based on the density of the peripheral pattern and, thereby, the amount of shift of an edge may be altered based on the density of the pattern in the step of the shifting of the edge so that the density of the pattern is uniformed.

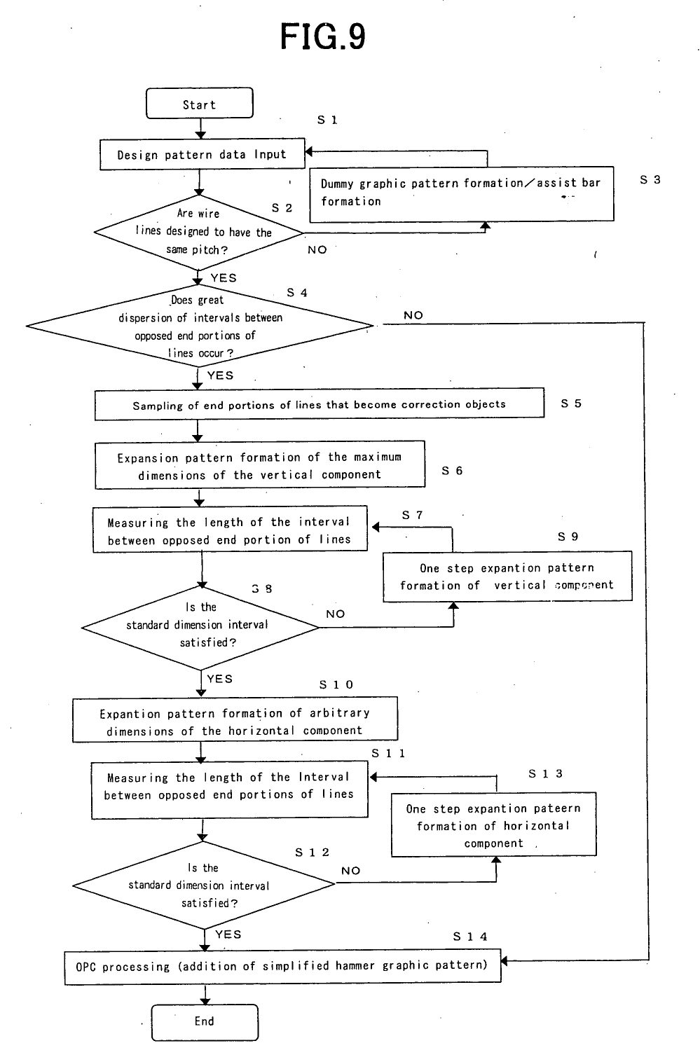

The sixth embodiment of the present invention is below described in reference to FIGS. 9 to 13. FIG. 9 is a flow chart of the semiconductor design layout pattern formation method according to the sixth embodiment of the present invention.

This embodiment includes the step of sampling an edge of an end portion of a line in the vertical or horizontal direction in the layout pattern; the step (S5) of calculating the edge interval between the edge of the end portion of the line and the adjacent edge, and of sampling an edge that becomes a correction object based on this calculation result; and the step of shifting the edge that becomes the correction object toward the adjacent edge, wherein an amount of edge that can be shifted is calculated in accordance with the edge interval at the time of the step of shifting the edge, as shown in FIG. 9, at the time of change of the form of the end portion of a line according to the fourth embodiment.

In this case, an arbitrary expansion pattern is formed at the end portion of the line in the design layout pattern (S6) After the formation of the expansion pattern; the interval between the opposed end portions of the lines is measured, and the expansion pattern is replaced with an expansion pattern of which the dimensions have been increased by one stage in the case the standard interval is not satisfied; and this process is repeated until the standard interval is satisfied (S7 to S9).

In the following, the procedure of the CAD processing algorithm for correcting end portions of lines is shown.

End portions 101 of lines having opposed intervals equal to or greater than the standard value are sampled from the entire layout pattern 100 (S5).

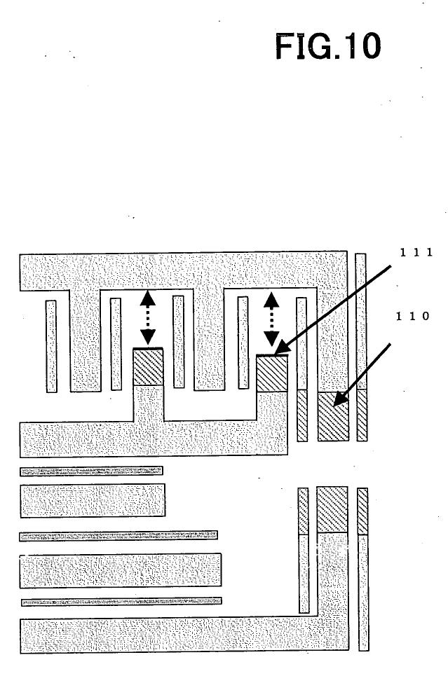

A pattern 110 of an arbitrary dimension for expansion solely in the vertical direction is formed at end portions 101 of a line as shown in FIG. 10 (S6).

Opposing intervals of the end portions of the lines of the pattern formed in S6 are measured, and end portions 111 of lines of which the opposing intervals do not satisfy the standard interval are sampled (S7, S8).

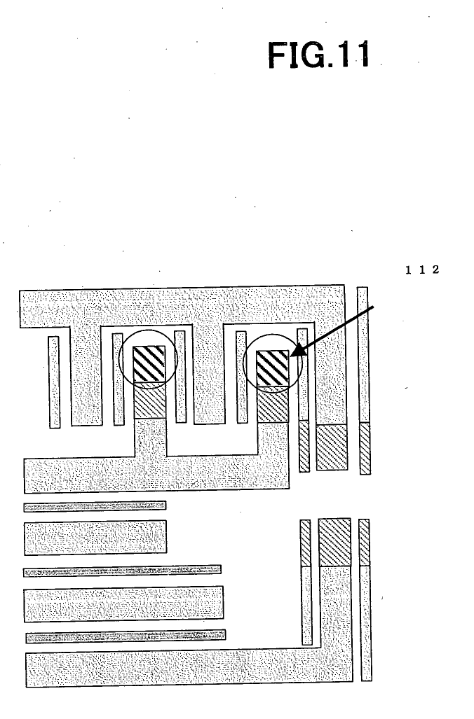

A pattern 112 of an arbitrary dimension for a further expansion of end portions 111 of the lines in the vertical direction is formed as shown in FIG. 11 (S9).

Processes from S7 to S9 are repeated until the end portions of the lines satisfy the standard intervals in the vertical direction.

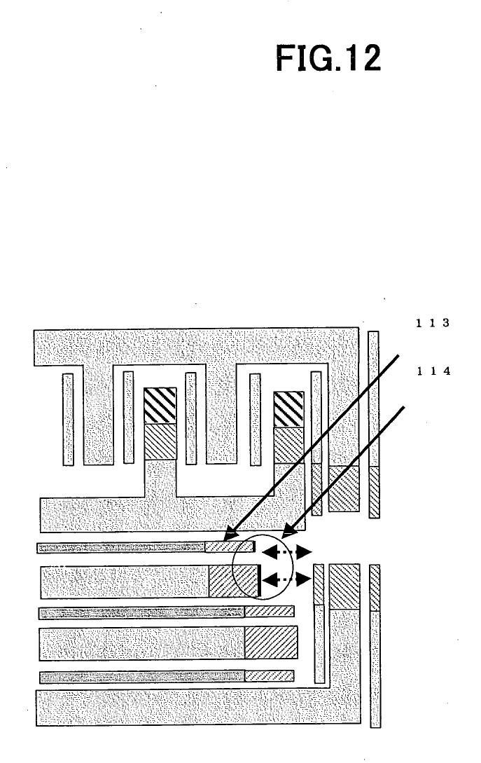

Next, end portions of lines having opposing intervals that are equal to or greater than the standard interval are sampled in the layout pattern formed in S5 to S9, and a pattern 113 of an arbitrary dimension for expansion of the end portions of the lines solely in the horizontal direction is formed as shown in FIG. 12 (S10).

The opposing intervals of the end portions of the lines in the layout pattern formed in S10 are measured, and end portions 114 of the lines that do not satisfy the standard interval are sampled (S11, S12).

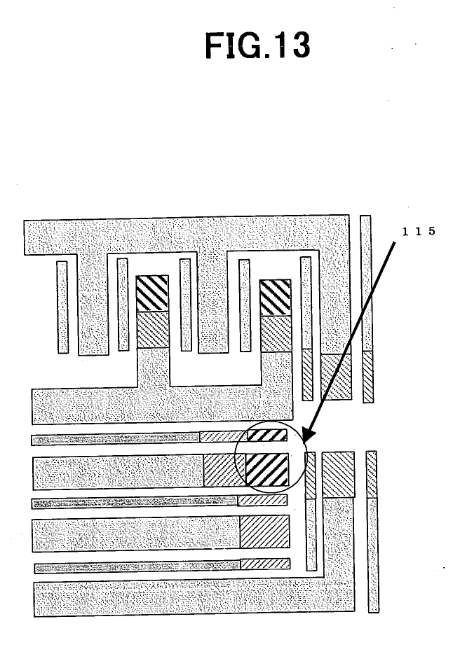

A pattern 115 of an arbitrary dimension for a further expansion of end portions 114 of the lines in the horizontal direction is formed as shown in FIG. 13 (S13).

Processes from S11 to S13 are repeated so that the expansion of the end portions of the lines is repeated until the end portions of the lines in the horizontal direction satisfy the standard interval, and thereby it becomes possible for the end portions of the lines in the entire layout pattern to satisfy the standard interval.

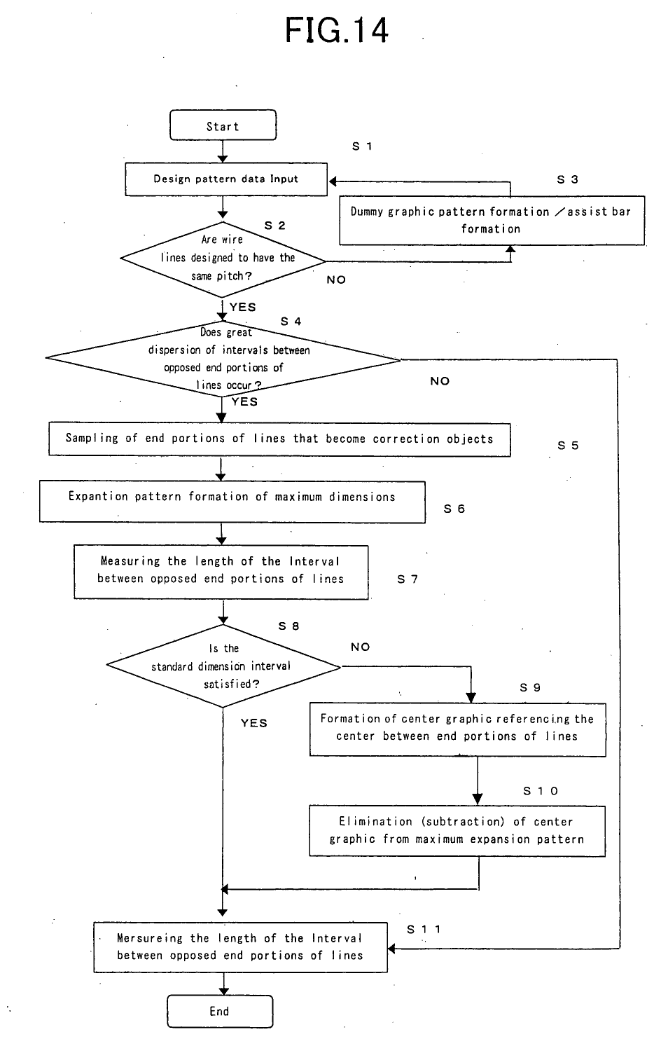

The seventh embodiment of the present invention is below described in reference to FIGS. 14 to 16. FIG. 14 is a flow chart of the semiconductor design layout pattern formation method according to the seventh embodiment of the present invention.

This embodiment includes the step of sampling an edge of an end portion of a line in the layout pattern; the step (S5) of calculating the edge interval between the edge of the end portion of the line and the adjacent edge, and of sampling an edge that becomes a correction object based on this calculation result; the step of forming an expansion pattern of the edge portion of the line in accordance with the edge interval: and the step of switching the expansion pattern with the edge that becomes the correction object so as to make the edge interval uniform, at the time of change in the form of an end portion of a line according to the fourth embodiment.

In this case, an expansion pattern of the maximum dimensions of the vertical factors, and of the horizontal factors, of end portions of lines in the design layout pattern is uniformly formed (S6), and a center graphic is formed referencing the center of the interval between the end portions of lines so as to have a line width of the standard interval, and this graphic is eliminated (retrogressed) from the expansion pattern in the case wherein the opposing interval of the end portions of the lines does not satisfy the standard interval (S7 to S10).

In the following the CAD processing algorithm for correcting end portions of the lines is shown.

End portions 101 of lines having opposing intervals equal to or greater than the standard interval are sampled in the entire layout pattern 100 (S5).

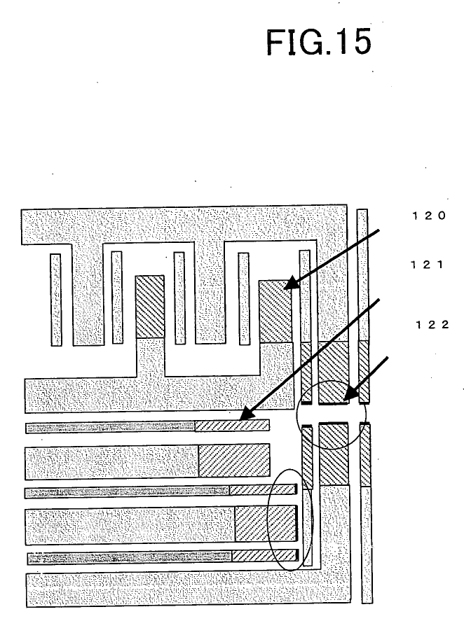

As shown in FIG. 15, a pattern 120 of the maximum dimensions for expansion of end portions 101 of lines solely in the vertical direction is formed (S6).

A pattern 121 of the maximum dimensions for expansion of end portions of lines solely in the horizontal direction is formed in the entire layout pattern formed in S6 (S6).

The opposing intervals of end portions of lines in the entire layout pattern formed in S6 are measured, and portions 122 of lines having intervals that do not satisfy the standard interval (causing a design error) (S7, S8).

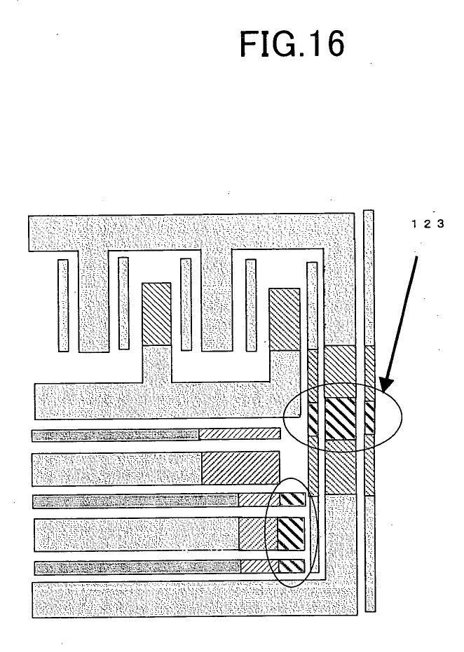

As shown in FIG. 16, a center graphic 123 having a line width equal to or greater than the standard interval is formed at an end portion 122 of a line referencing the center of the interval between the opposed lines (S9).

Center graphic 123 is eliminated from expansion pattern 121, and thereby it becomes possible for all of the end portions of the lines in the entire layout pattern to secure the standard interval (S10).

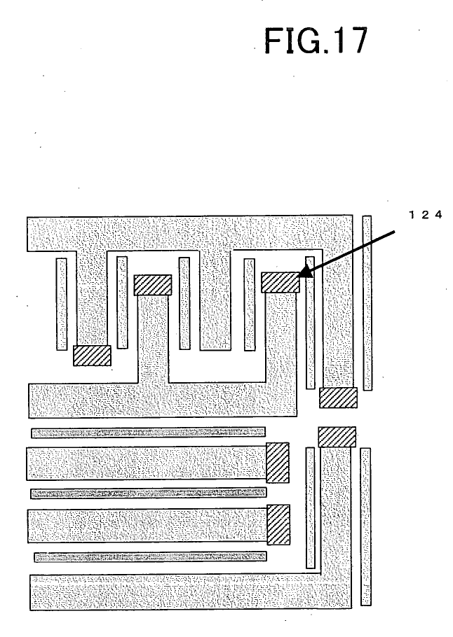

In addition, as shown in FIG. 17, a simplified hammer graphic (or serif) 124 is formed through OPC processing (S14 of FIGS. 4 and 9, S11 of FIG. 14), on the premise that the opposing intervals of the end portions of the lines in the design layout pattern have the same distance according to Embodiments 5, 6 or 7.

What is claimed is:

1. In a semiconductor design layout pattern formation method used in a layout pattern on a wafer wherein wire lines are not designed to have the same pitch,
a dummy graphic pattern having no relation to the wiring is formed in a non-wired region of said layout pattern, so that said dummy graphic pattern, and said wire lines have the same intervals.

2. In a semiconductor design layout pattern formation method used in a layout pattern on a wafer wherein wire lines are not designed to have the same pitch,
a microscopic graphic pattern having no relation to the wiring, which is not resolved on said wafer by means of a projection optics system, is formed in a non-wired region of said layout pattern, so that said microscopic graphic pattern, and said wire lines have the same intervals.

3. In a semiconductor design layout pattern formation method used in a layout pattern on a wafer wherein wire lines are designed to have the same pitch,
The semiconductor design layout pattern formation method includes the step of making uniform spaces between end portions of wire lines and the patterns aligned in the direction of these wire lines in said layout pattern.

4. In a semiconductor design layout pattern formation method that is used to form a desired layout pattern on a wafer by means of a projection optics system,
the semiconductor design layout pattern formation method includes:
the step of sampling an edge of an end portion of a line in said layout pattern;
the step of calculating the edge interval between the edge of said end portion of the line and the adjacent edge, and of sampling an edge that becomes a correction object, based on the calculation result; and
the step of shifting the edge that becomes the correction object toward the adjacent edge so as to make said edge interval uniform.

5. In a semiconductor design layout pattern formation method that is used to form a desired layout pattern on a wafer by means of a projection optics system,
the semiconductor design layout pattern formation method includes:
the step of sampling an edge of an end portion of a line in said layout pattern depending on the density of the peripheral pattern;
the step of calculating the edge interval between the edge of said end portion of the line and the adjacent edge, and of sampling an edge that becomes a correction object, based on the calculation result; and
the step of shifting the edge that becomes the correction object toward the adjacent edge, wherein
the amount of shift of the edge is changed depending on the pattern density so as to make the pattern density uniform in the step of shifting said edge.

6. In a semiconductor design layout pattern formation method that is used to form a desired layout pattern on a wafer by means of a projection optics system,
the semiconductor design layout pattern formation method includes:
the step of sampling an edge of an end portion of a line in the vertical direction in said layout pattern;
the step of calculating the edge interval between the edge of said end portion of the line and the adjacent edge, and of sampling an edge that becomes a correction object, based on the calculation result; and
the step of shifting the edge that becomes the correction object toward the adjacent edge, wherein
the amount of the edge that can be shifted is calculated in accordance with said edge interval in the step of shifting said edge.

7. In a semiconductor design layout pattern formation method that is used to form a desired layout pattern on a wafer by means of a projection optics system,
the semiconductor design layout pattern formation method includes:
the step of sampling an edge of an end portion of a line in the horizontal direction in said layout pattern;
the step of calculating the edge interval between the edge of said end portion of the line and the adjacent edge, and of sampling an edge that becomes a correction object, based on the calculation result; and
the step of shifting the edge that becomes the correction object toward the adjacent edge, wherein
the amount of the edge that can be shifted is calculated in accordance with said edge interval in the step of shifting said edge.

8. In a semiconductor design layout pattern formation method that is used to form a desired layout pattern on a wafer by means of a projection optics system,
the semiconductor design layout pattern formation method includes:
the step of sampling an edge of an end portion of a line in said layout pattern;
the step of calculating the edge interval between the edge of said end portion of the line and the adjacent edge, and of sampling an edge that becomes a correction object based on the calculation result;
the step of forming an expansion pattern of said end portion of the line in accordance with said edge interval; and
the step of switching said expansion pattern with the edge that becomes said correction object, so as to make said edge interval uniform.

9. The semiconductor design layout pattern formation method according to claim 8, that includes:
the step of calculating the edge interval between the edge of the end portion of the line, and the adjacent edge in the layout pattern after the expansion pattern has been switched, and of sampling an edge that becomes a correction object based on the calculation result;
the step of forming a center graphic, referencing the center of said edge interval, concerning the edge that becomes said correction object; and
the step of eliminating said center graphic from said expansion pattern.

10. A graphic pattern formation unit provided with a means for making the pitch between the wires and the peripheral pattern uniform, in accordance with the semiconductor design layout pattern formation method according to claim 1 or 2.

11. A graphic pattern formation unit provided with a means for making uniform the spaces between the end portions of lines and the pattern aligned in this line direction in the layout pattern, according to the semiconductor design layout pattern formation method according to claim 4, 5, 6, 7 or 8.
